(19) United States
(12) Patent Application Publication
(10) Pub. No.: US 2013/0307722 A1
(43) Pub. Date: Nov. 21, 2013

(54) Automatic Detection of Mode of Transportation by Analyzing Signal Strength of Received GNSS Signals and Speed

(71) Applicant: Shahram Rezaei, Danville, CA (US)

(72) Inventor: Shahram Rezaei, Danville, CA (US)

(21) Appl. No.: 13/847,038

(22) Filed: Mar. 19, 2013

Related U.S. Application Data
(60) Provisional application No. 61/650,686, filed on May 23, 2012.
(60) Provisional application No. 61/647,168, filed on May 15, 2012.
(60) Provisional application No. 61/647,326, filed on May 15, 2012.

(51) Int. Cl. G01S 19/00

(52) U.S. Cl. CPC G01S 19/00
USPC 342/357.2

(57) ABSTRACT

Object of the present invention is to provide a method to reduce power consumption of location based services applications, that run on mobile devices, by utilizing processor and positioning resources only when location changes. A method also is provided for detecting or inferring mode of transportation of user of a GNSS-enabled mobile device, such as smart phone, tablet, etc. Modes of transportation consist of: traveling on foot, biking, motor biking, driving or riding on a car, riding on bus, and riding on train. This method is based on analyzing signal strength information of GNSS signals received at location of the user and speed. The latter is used to make distinction between travelling on foot, biking, and motor biking modes. GNSS signal cannot penetrate metal, therefore when the mobile device is inside a vehicle, such as car, bus, or train, GNSS signals that their path collides with roof or metal body of the vehicle would be weak and have low SNR.

### BACKGROUND OF THE INVENTION

1. Field of the Invention

The present invention relates to any mobile device that is equipped with a positing unit and capable of running software applications, referred to here as ‘Application’ and abbreviated to ‘App’. Mobile devices in this document refer to any portable or wearable devices that are capable of running software programs and equipped with one or more positioning units. Some examples of such devices are: smart phones, tablets, and cameras. The positioning unit may be Global Positioning System (GPS), Glonass

(Russian satellite based global positioning system, equivalent to GPS), Cellular or Wi-Fi network-based positioning, etc.

This invention is in particular related to automatically detecting or inferring mode of transportation, including: Travelling on foot, Biking, Motor-Biking, Driving or Riding in a Car, Riding on Bus, and Riding on Train, in real-time or offline by analyzing signal strength information of GNSS satellites and speed.

2. Description of the Prior Art

Mobile devices, especially smart phones (such as iPhone, Android based phones, Windows Mobile phones, Blackberry, etc), now come routinely equipped with GNSS navigation receivers that provide position fixes for their users.

GNSS is satellite based navigation system. There are several GNSS systems, currently operational or in development. GPS is the main and oldest system. Russia's GLONASS is the other fully operational system. Europe is building its own GALILEO system and so are several other countries, including China, India, and Japan. GPS uses a set of 32 satellites to allow ground-based users to determine their locations. GPS satellites are spaced in orbit such that a minimum of six satellites are in view at any one time to a user. GLONASS uses a set of 24 satellites. Each such satellite transmits an accurate time and position signal. GNSS receivers measure the time delay for the signal to reach it, and the apparent receiver-satellite distance is calculated from that. Strength of this signal is highest when there is line of sight between receiver and satellite, i.e. nothing blocking the signal. Signal becomes weak when reaches the receiver through reflection. GNSS signals can penetrate plastic, glass, and composite materials but will not penetrate any metal, including roof of vehicle that is normally made of steel.

In today's world, many people own and carry GNSS (mainly

GPS) enabled mobile phones. Due to the E911 mandate, wireless carriers must be able to locate a 911 mobile-phone caller to within 50 to 300 meters of accuracy. Various technologies have been used to satisfy this mandate including embedded GNSS hardware in mobile phones. The implementation of such positioning technologies has led to the creation of a class of software application known as Location-Based Services (LBS) that use the device's location in coordination with other data to create location-aware applications. LBS applications heavily use many power-consuming features of mobile devices; for example, they use built-in GNSS receiver for positioning, or the radio to receive and send data.

A successful LBS application running on a mobile phone shouldn't drain the phone's battery. Unfortunately, battery capacity is not increasing at the same pace as the development of new power demanding features for mobile devices. If a specific LBS application drains or significantly shortens a battery's lifetime, then consumers might stop using the service or any App's utilizing this service. Thus, LBS applications must be designed to minimize power consumption while using phone's features, especially if the service runs for large durations of time.

Detecting mode of transportation of the person carrying the mobile phone is necessary or desirable for most of LBS application. For example an application that aims to deliver safety warnings to drivers, for instance slow traffic ahead warning, needs information that user is driving. Another example is giving warning to a person riding on a public transportation vehicle, like Bus or Train, about possible call drop when he or she is talking on his/her phone and approaching a zone that wireless signal is weak or not available at all. A third example is delivering store coupons to a user walking nearby a store.

The National Marine Electronics Association (NMEA) has developed a specification that defines the interface between various pieces of marine electronic equipment. The standard permits marine electronics to send information to computers and to other marine equipment. GNSS receiver communication is defined within this specification. Almost all GNSS receivers, including ones embedded in mobile devices, output data in NMEA format. This data includes the complete PVT (position, velocity, time) solution computed by the GNSS receiver. The idea of NMEA is to send a line of data called a sentence that is totally self-contained and independent from other sentences. There are standard sentences for each device category and there is also the ability to define proprietary sentences for use by the individual company. All of the standard sentences have a two letter prefix that defines the device that uses that sentence type, which is followed by a three letter sequence that defines the sentence contents. For GPS system the prefix is GP (GL for GLONASS, GA for GALILEO, and so forth). One of standard sentences is GPGSV (GLGSV for GLONASS, GAGSV for GALIELO satellites, and so forth) that shows data about the satellites that the receiver might be able to find. This data include: 1) elevation or altitude (wikipedia.org/wiki/Altitude_(astronomy)) angle in degrees, 2) azimuth (wikipedia.org/wiki/Azimuth) angle in degrees, and 3) signal to noise ratio (SNR) value in dBHz
(wikipedia.org/wiki/Decibel). Note that one GSV sentence only can provide data for up to 4 satellites and thus there may be up to 4 sentences for the full information.

### SUMMARY OF THE INVENTION

Object of the present invention is to provide a method to reduce power consumption of Location Based Services applications, running on mobile devices, by utilizing power-consuming features of the device, including but not limited to processor (CPU) and GPS, only when location is significantly changing. Object of the present invention is also to provide a method to detect or infer mode of transportation of user of a GNSS-enabled mobile device from GNSS signal strength information and speed. Mode of transportation could be travelling on foot, biking, motor biking, driving or riding in a car, riding on bus, or riding on a train.

In one aspect, a method is provided of using a satellite navigation receiver carried by a user to determine a mode of locomotion of the user. The satellite navigation receiver receives signals from multiple satellites. For each of the plurality of satellites, the satellite navigation receiver determines at least one signal characteristic of a signal received from the satellite. A speed of the user is determined, and the signal characteristic and the speed of the user ared used to determine a mode of locomotion of the user from among multiple possible different modes of locomotion. The different modes of locomotion may include foot travel and enclosed vehicular travel, such as bicycle, motorcycle, car, bus and train. The signal characteristic may be signal strength. The method may include comparing signal strengths of different ones of the satellites and determining a number or proportion of satellites of comparatively low signal strength. Pronounced differences in signal strength may be taken as an indication of enclosed vehicular travel. The number or proportion of satellites of comparatively low signal strength may be taken as an indication of a vehicle size and hence type of vehicle used for enclosed vehicular travel. In particular: car travel may be indicated when the number or proportion of satellites of comparatively low signal strength is comparatively low; bus travel may be indicated when the number or proportion of satellites of comparatively low signal strength is moderate; and train travel may be indicated when the number or proportion of satellites of comparatively low signal strength is comparatively high.
In another aspect, a non-transitory computer-readable medium is provided for using a satellite navigation receiver carried by a user to determine a mode of locomotion of the user, with instructions for the satellite navigation receiver receiving signals from multiple satellites. For each of the plurality of satellites, the satellite navigation receiver determines at least one signal characteristic of a signal received from the satellite. A speed of the user is determined, and the signal characteristic and the speed of the user are used to determine a mode of locomotion of the user from among multiple possible different modes of locomotion, in similar fashion as previously described.

In another aspect, a server system is provided for using a GNSS-capable mobile electronic device carried by a user to determine a mode of locomotion of the user. A network interface is provided for receiving from the mobile electronic device information indicative of a speed of the user and, for each of multiple satellites, at least one signal characteristic of a signal received from the satellite. A processor is configured for using the signal characteristic and the speed of the user to determine a mode of locomotion of the user from among multiple possible different modes of locomotion, in similar fashion as previously described.

### IN THE DRAWINGS

FIG. 1 represents a block diagram embodiment of the present invention;

FIG. 2 represents states machine diagram for processor states;

FIG. 3 represents states machine diagram for data collections states;

FIG. 4 represents states machine diagram for transportation modes of the mobile device;

FIG. 5 is a sketch diagram that shows path of GNSS signals that reach a location on Earth in absence of any occlusion or blockage;

FIG. 6 is a sketch diagram that shows path of GNSS signals that reach a person travelling on foot;

FIG. 7 is a sketch diagram that shows path of GNSS signals that reach a person riding on a typical bike;

FIG. 8 is a sketch diagram that shows path of GNSS signals that reach a person riding on a typical motor bike;

FIG. 9 is a sketch diagram that shows path of GNSS signals that reach a person driving or riding in a typical personal car;

FIG. 10 is a diagram that shows path of GNSS signals that reach a person riding on a typical bus;

FIG. 11 is a diagram that shows path of GNSS signals that reach a person riding on a typical train;

FIG. 12 is a diagram that illustrates how to examine whether signal of a GNSS satellite hits roof of a car or not;

### DETAILED DESCRIPTION OF THE PREFERRED EMBODIMENT

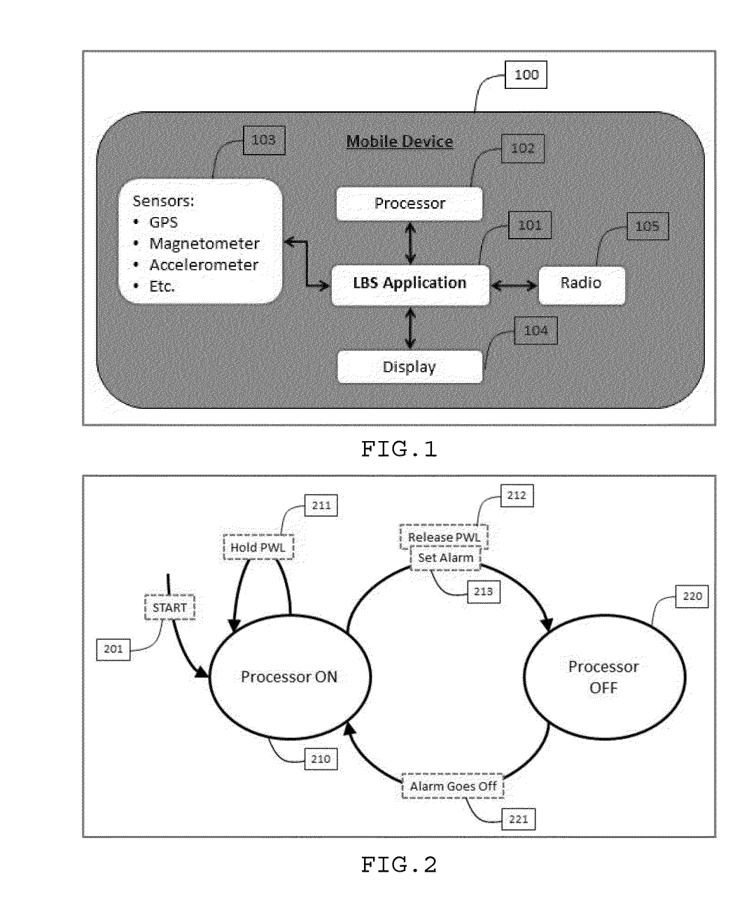

FIG. 1 represents a block diagram embodiment of the present invention, and is referred to herein by the general reference numeral 100. Major components of the system are: LBS application 101, processor (CPU) 102, sensors 103, display 104, and radio 105. Processor 102 has to be running for LBS application 101 to run. The application 101 turns Sensors 103 ON in order to collect and calculate location related information of the phone. The application 101 may display some of its information on display (screen) 104 of the device.

FIG. 2 represents states machine diagram for processor states based on our power saving method. When application is first started 201, processor's state is ON 210. Processor 102 is one of biggest sources of power consumption in a typical mobile device and to reduce power consumption, application should allow it to be turned off. In general, the mobile device itself handles power states of the processor, but the application can request operating system of the device to keep the processor on. For example, in an Android operating system, to keep the processor ON, a so called Partial WakeLock needs to be acquired by the application
(developer.android.com/reference/android/os/PowerManager.html). We call this request to keep the processor on, Processor Wake Lock (PWL) in this patent specification. Upon acquiring and holding PWL 211, the processor will continue running, even if user presses the power button to off state. Application 101 should try to release PWL 212 as much as possible so that processor can go to the OFF state 220, in order to save power. At the same time that PWL release 212 is handled, application should set an alarm 213, in order to wake up the processor after certain amount of time. For example in Android system, RTC alarm may be set using Android's AlarmManager
(developer.android.com/reference/android/app/AlarmManager.html) service. When the alarm goes off 221, the application resumes operation.

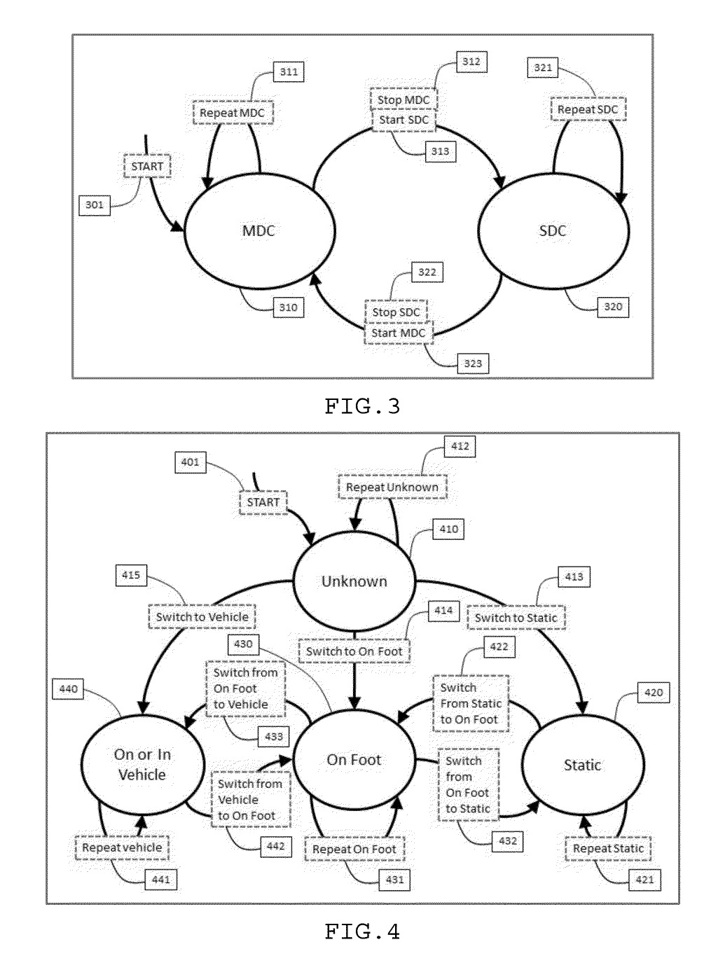

FIG. 3 represents states machine diagram for data collection states to enable power saving. There are two data collection states: Mode Data Collection (MDC) 310 and Single Data Collection (SDC) 320. At startup 301, data collection state is MDC. In this state, the application 101 turns all or some of positioning sensors ON and records their measurements continuously in order to infer mode of transportation. MDC may be repeated 311 based on the inferred transportation mode or other factors. But in most cases, data collection switches from MDC to SDC by stopping MDC 312 and starting SDC 313. In steady state, the application should repeat SDC 321 as much as possible, since it is less power consuming than MDC. In this state, all or some of the positioning sensors are turned ON only to capture one or a few position data and then are turned back OFF, again to save power. Time interval between data collections in SDC mode may be longer in low speed transportation modes, for example 30 seconds while walking, and shorter in high speed modes, for example 10 seconds while driving. After some period of time, SDC is stopped 322 and MDC is turned back ON 323. This repetition of MDC is sometimes required to confirm or update mode of transportation
(wikipedia.org/wiki/Mode_of_transport).

FIG. 4 represents states machine diagram for transportation modes of the mobile device. Mode of transportation plays a key role in the power saving method presented in this patent specification. At startup 401, the mode is set to Unknown 410; at this point data collection mode is MDC 302, as described above. The application should infer the mode from data collected during MDC 302 and/or SDC 306 modes. Several possible modes may be considered, such as static, walking, running, biking, driving, riding bus, etc. Without loss of generality, here we describe transitions between different modes using four states: Unknown 410, Static 420, On Foot 430 that covers walking, running, jogging, and similar kinds of movement on foot, and On/In Vehicle 440 that covers driving, riding on bus, riding train, riding airplane, and similar transportations on or inside a vehicle. The application may switch mode from Unknown to itself 412, to Static 413, to On foot 414, or to On/In Vehicle 415. From Static, the mode may be reconfirmed 421 or switched to On Foot 422. It is not possible to go from Static to On/In Vehicle without first being On Foot. On Foot mode may be repeated 431, switched to Static 432, or changed to On/In Vehicle 433. Finally, On/In Vehicle mode may be repeated 441 or transition to On Foot 442.

The mode may transition from Unknown to Static 413, based on observing none or very little deviation in three axes acceleration and/or magnetometer values. Most mobile devices, in particular smart phones, have accelerometer and magnetometer sensors. Equation below describes how to calculate deviation “Δa” between two (1 and 2) set of three axes (x, y, and z) acceleration (a) measurements:

Δa=|aₓ(2)−aₓ(1)|+|a_{y}(2)−a_{y}(1)|+|a_{z}(2)−a_{z}(1)|

One criterion for detecting static mode is:

If Δa<0.1 m/ŝ2→mode is Static

Since in Static mode, position does not change, the positioning unit is completely turned off to save power, but application continues to get data in MDC mode 311 from accelerometer and/or magnetometer sensors, that consume significantly less power compare to the positioning unit. This data may reconfirm Static mode 421, or indicate movement that results into change of mode to On Foot 422, followed by turning GPS or other positioning sensors on in order to capture change in location and speed.

To save power, the application should release PWL as much as possible 212. Here are a few conditions that PWL may be released:
Mode has been static for an extended amount of time, for example 5 minutes.
GPS and/or positioning sensors are not able to deliver valid location information for an extended amount of time, for example 2 minutes.
Mode is On Foot, but the distance traveled during a period of time is very small, for example 30 meters.

Basically, application should release the PWL whenever it predicts that position or status of sources that provide position will not change for a period of time. It chooses duration of the alarm 213 that is set upon releasing PWL according to its expectation of when conditions resulted in releasing the PWL maybe first violated in the future. For example, when mode has been Static for a while and it is night time, it is reasonable to predict that the device will stay static for a long time, like 30 minutes, in the future.

This section describes a method to detect or infer mode of transportation of user of a GNSS-enabled mobile device from GNSS signal strength information and speed. Mode of transportation could be travelling on foot, biking, motor biking, driving or riding in a car, riding on bus, or riding on a train.

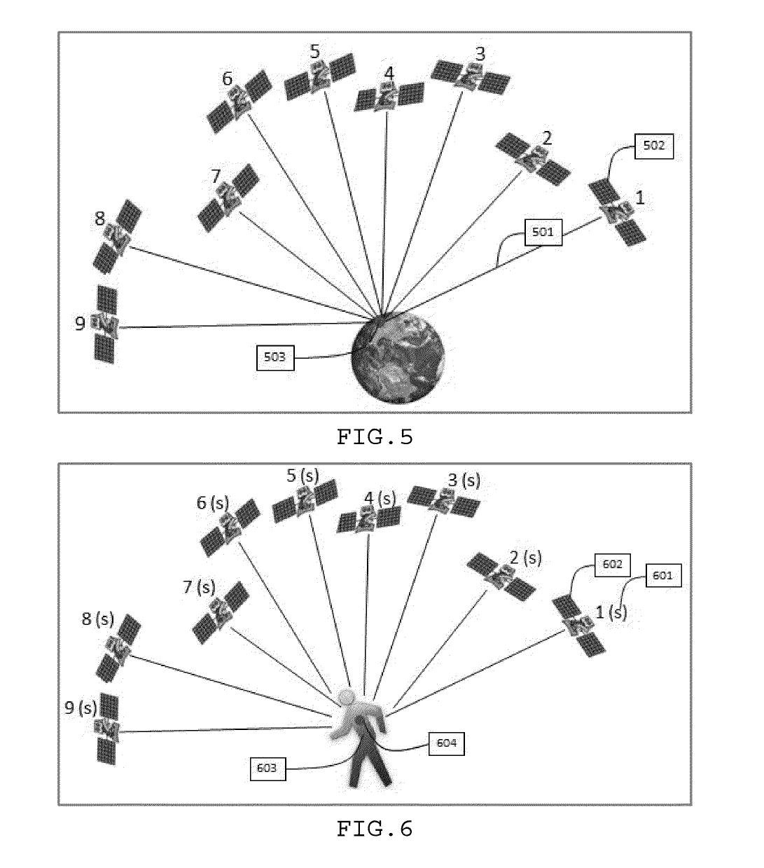

FIG. 5 shows schematically signal path 501 of nine GNSS satellites 502 that are assumed to be visible at location of mobile phone device 503 on Earth. The satellites have been numbered from 1 to 9. Thus, there are nine elements of type 502 and 503.

FIG. 5 and its following figures do not represent a real case scenario; they are meant to describe a general case scenario where several satellites are visible at location of a mobile device. Number of visible satellites varies by location and time of day, but it is typically between 8 and 12.

FIG. 6 is a sketch diagram that shows anticipated signal strength status 601 of GNSS satellites 602 when received at location of a person and travelling on foot 603 and carrying a mobile phone device 604. In this case, since person and thus the GNSS receiver inside the mobile phone device 604 is not surrounded by an object, made fully or partially of metallic material, signal strength status 601 of signal from all nine satellites 602 would be strong (shown by (s) in the figure). So, the criterion for detecting on foot transportation modes, including waking, running, hiking, etc., is observing high signal to noise ratio (SNR) value for all or most of satellites. SNR values are reported by all GNSS receivers that follow NMEA standard.

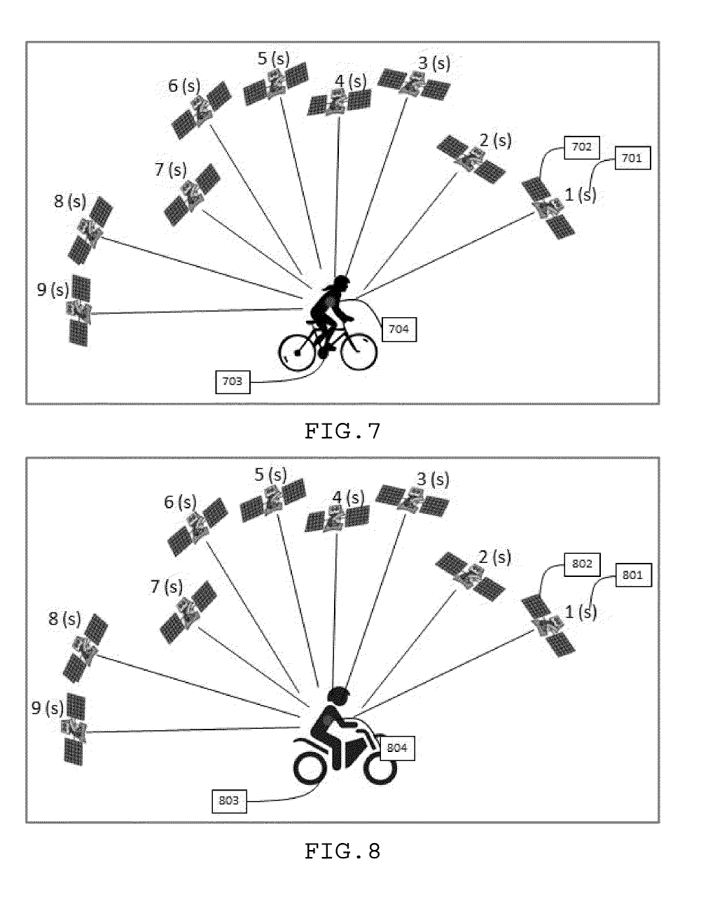

FIG. 7 is a sketch diagram that shows anticipated signal strength status 701 of GNSS satellites 702 when received at location of a person riding bike 703 and carrying mobile phone device 704. Similar to the mode of travelling on foot, in this case also since person is not surrounded by an object, made fully or partially of metallic material, signal strength status 701 of signal from all nine satellites 703 would be strong (shown by (s) in the figure). So, the criterion for inferring riding on bike is observing high SNR value for all or most of satellites. To differentiate between travelling on foot and biking, value of speed is examined. Average biking speed is about 10 meters per second (˜22 mph) while average walking speed for an adult is 1-2 meters per second (˜2-5 mph).

FIG. 8 is a sketch diagram that shows anticipated signal strength status 801 of GNSS satellites 802 when received at location of a person riding motor bike 803 and carrying mobile phone device 804. Similar to travelling on foot and riding on bike modes, in this case also since person is not surrounded by an object, made fully or partially of metallic material, signal strength status 801 of signal from all nine satellites 803 would be strong (shown by (s) in the figure). So, the criterion for inferring riding on motor bike is observing high SNR value for all or most of satellites. To differentiate between biking and motor-biking, value of speed is tested. Motor-biking speed can be as high as 35 meters per second (˜80 mph) which is significantly larger than average biking speed at 10 meters per sec (˜22 mph).

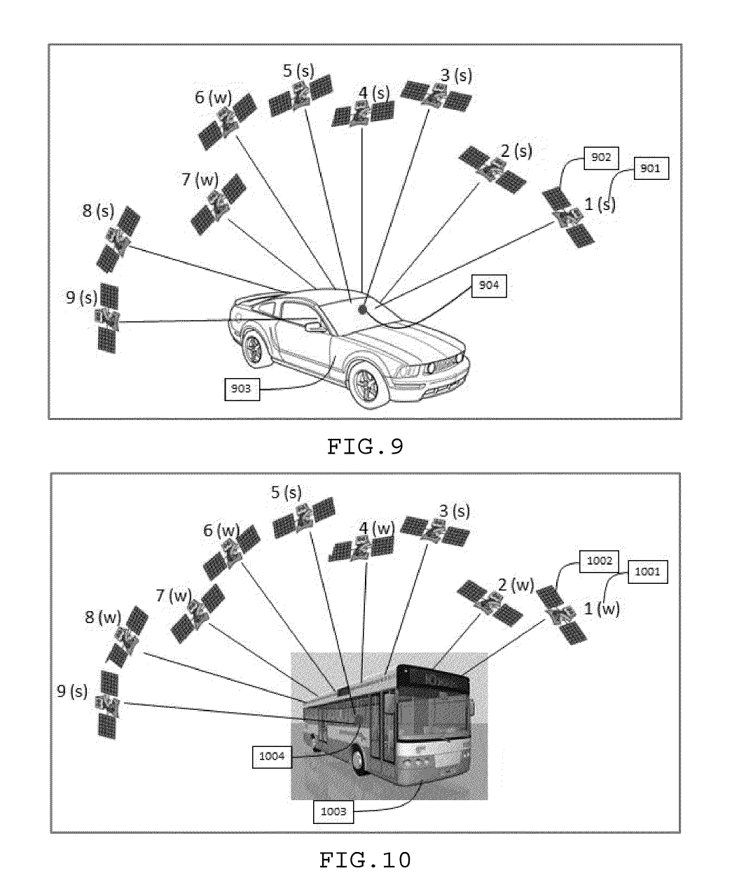

FIG. 9 is a sketch diagram that shows anticipated signal strength status 901 of GNSS satellites 902 when received at location of a person driving or riding in a typical personal car 903 and carrying mobile phone device 904. Unlike previous modes, i.e. travelling on foot, riding bike, and riding motor-bike, in this case since person is inside vehicle, which its body and roof are mostly made of steel or other metallic materials, signal strength status 901 of signal from some of satellites 903 would be weak (shown by (w) in the figure), in particular ones that hit roof or body of the car. In the diagram shown in FIG. 9 satellites 1-5 and 8-9 are still anticipated to have strong SNR (shown by (s) in the figure), this is because their signal goes through windshield and windows that are made of glass and allow GNSS signal penetration. So, the criterion for inferring driving or riding in a personal car are observing high SNR values for satellites that their signal path do not collide with roof or metal body of the vehicle.

FIG. 10 is a sketch diagram that shows anticipated signal strength status 1001 of GNSS satellites 1002 when received at location of a person riding on a typical bus 1003 and carrying mobile phone device 1004. Similar to the previous mode, i.e. driving or riding in a personal car, in this case also since person is inside vehicle, which its body and roof are mostly made of steel or other metallic materials, signal strength status 1001 of signal from some of satellites 1003 would be weak (shown by (w) in the figure), in particular ones that hit roof or body of the bus. In the diagram shown in FIG. 10 only satellites 3, 5 and 9 are anticipated to have strong signal strength (shown by (s) in the figure), this is because their signal goes through side windows of the bus. In general, since buses are longer and wider than cars, signal strength status 1001 of signals from more GNSS satellites is weaker inside a bus than car. So, the criterion for inferring riding bus are observing high SNR values for satellites that their signal path do not collide with roof or metal body of the bus.

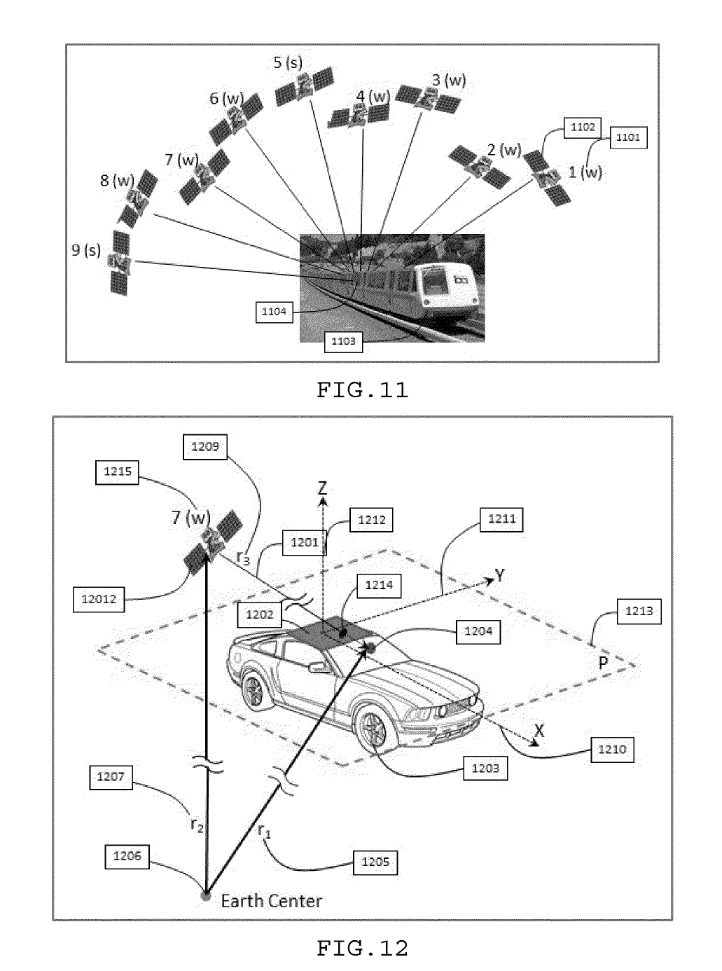

FIG. 11 is a sketch diagram that shows anticipated signal strength status 1101 of GNSS satellites 1102 when received at location of a person riding on a typical train 1103 and carrying mobile phone device 1104. Similar to the previous two modes, i.e. driving or riding a car and riding on bus, in this case also since person is inside vehicle, which its body and roof are mostly made of steel or other metallic materials, signal strength status 1101 of signal from some of satellites 1103 would be weak (shown by (w) in the figure), in particular ones that hit roof or body of the bus. In the diagram shown in FIG. 11 only satellites 5 and 9 are anticipated to have strong signal strength (shown by (s) in the figure), this is because their signal goes through side windows of the bus. In general, since trains are longer and wider than cars and also buses, signal strength status of signals from almost all GNSS satellites is weak inside a train. So, the criterion for inferring riding train is observing low SNR values for almost all satellites or ones that their signal path collide with roof or metal body of the train.

FIG. 12 illustrates how to check if path of a GNSS signal 1201 collides with roof 1202 of a car 1203, wherein there is a GNSS-enabled mobile device 1204. First, position vector r₁ 1205 between Earth center 1206 and mobile device's location 1204 is computed in WGS-84 (wikipedia.org/wiki/World_Geodetic_System) coordinate system. All GNSS receivers output position and velocity information in this coordinate system (Russia's GLONASS system uses PZ-90 coordinate system, which is only a few centimeters different from WGS-84). Computing position vector between two points in WGS-84 coordinate system is trivial. Next, position vector r₂ 1207 between Earth center 1206 and location of GNSS satellite 1208 is computed in WGS-84 coordinate system. Vector r₃ 1209 is the difference between vectors r₁ 1205 and r₂ 1207 and represent direction vector between the GNSS satellite 1208 and the mobile device 1204. We want to check is r₃ 1209 hits roof 1202 of the car 1203. We form a local coordinate system with origin at center of the roof 1202, X-axis 1210 along longitudinal direction, Y-axis 1211 along lateral direction, and Z-axis 1212 normal to the plane 1213 that contains X and Y axes. In the example shown in this figure, GNSS signal 1201 intersects the roof 1202 at point 1214. Since, coordinates of this point in the local XYZ coordinate system lie within dimension of the roof 1202, we conclude that GNSS signal 1201 from satellite 1208 is blocked by roof 1202 and thus anticipate its signal strength 1315 be weak (shown by (w) in the figure). Similar technique can be used to check if a GNSS signal hits body of car or roof/body of bus or train.

What is claimed is:

1. A method of using a satellite navigation receiver carried by a user to determine a mode of locomotion of the user, comprising:
the satellite navigation receiver receiving signals from a plurality of satellites;
for each of the plurality of satellites, the satellite navigation receiver determining at least one signal characteristic of a signal received from the satellite;
determining a speed of the user; and
using the signal characteristic and the speed of the user to determine a mode of locomotion of the user from among a plurality of possible different modes of locomotion.

2. The method of claim 1, wherein the plurality of different modes of locomotion comprise foot travel and enclosed vehicular travel.

3. The method of claim 2, wherein the plurality of different modes of locomotion comprise foot travel, bicycle, motorcycle, car, bus and train.

4. The method of claim 1, wherein the signal characteristic is signal strength.

5. The method of claim 4, comprising comparing signal strengths of different ones of the satellites and determining a number or proportion of satellites of comparatively low signal strength.

6. The method of claim 5, wherein pronounced differences in signal strength are taken as an indication of enclosed vehicular travel.

7. The method of claim 6, wherein the number or proportion of satellites of comparatively low signal strength is taken as an indication of a vehicle size and hence type of vehicle used for enclosed vehicular travel.

8. The method of claim 7, wherein at least of the following:
car travel is indicated when the number or proportion of satellites of comparatively low signal strength is comparatively low;
bus travel is indicated when the number or proportion of satellites of comparatively low signal strength is moderate; and
train travel is indicated when the number or proportion of satellites of comparatively low signal strength is comparatively high.

9. A non-transitory computer-readable medium for using a satellite navigation receiver carried by a user to determine a mode of locomotion of the user, comprising instructions for:
the satellite navigation receiver receiving signals from a plurality of satellites;
for each of the plurality of satellites, the satellite navigation receiver determining at least one signal characteristic of a signal received from the satellite;
determining a speed of the user; and
using the signal characteristic and the speed of the user to determine a mode of locomotion of the user from among a plurality of possible different modes of locomotion.

10. The apparatus of claim 9, wherein the plurality of different modes of locomotion comprise foot travel and enclosed vehicular travel.

11. The apparatus of claim 10, wherein the plurality of different modes of locomotion comprise foot travel, bicycle, motorcycle, car, bus and train.

12. The apparatus of claim 9, wherein the signal characteristic is signal strength.

13. The apparatus of claim 12, comprising instructions for comparing signal strengths of different ones of the satellites and determining a number or proportion of satellites of comparatively low signal strength.

14. The apparatus of claim 13, wherein pronounced differences in signal strength are taken as an indication of enclosed vehicular travel.

15. The apparatus of claim 14, wherein the number or proportion of satellites of comparatively low signal strength is taken as an indication of a vehicle size and hence type of vehicle used for enclosed vehicular travel.

16. The apparatus of claim 15, wherein at least of the following:
car travel is indicated when the number or proportion of satellites of comparatively low signal strength is comparatively low;
bus travel is indicated when the number or proportion of satellites of comparatively low signal strength is moderate; and
train travel is indicated when the number or proportion of satellites of comparatively low signal strength is comparatively high.

17. A server system for using a GNSS-capable mobile electronic device carried by a user to determine a mode of locomotion of the user, comprising:
a network interface for receiving from the mobile electronic device information indicative of a speed of the user and, for each of a plurality of satellites, at least one signal characteristic of a signal received from the satellite; and
a processor configured for using the signal characteristic and the speed of the user to determine a mode of locomotion of the user from among a plurality of possible different modes of locomotion.

18. The apparatus of claim 17, wherein the plurality of different modes of locomotion comprise foot travel and enclosed vehicular travel.

19. The apparatus of claim 18, wherein the plurality of different modes of locomotion comprise foot travel, bicycle, motorcycle, car, bus and train.

20. The apparatus of claim 17, wherein the signal characteristic is signal strength.

21. The apparatus of claim 20, comprising wherein the processor is configured for comparing signal strengths of different ones of the satellites and determining a number or proportion of satellites of comparatively low signal strength.

22. The apparatus of claim 21, wherein pronounced differences in signal strength are taken as an indication of enclosed vehicular travel.

23. The apparatus of claim 22, wherein the number or proportion of satellites of comparatively low signal strength is taken as an indication of a vehicle size and hence type of vehicle used for enclosed vehicular travel.

24. The apparatus of claim 23, wherein at least of the following:
car travel is indicated when the number or proportion of satellites of comparatively low signal strength is comparatively low;
bus travel is indicated when the number or proportion of satellites of comparatively low signal strength is moderate; and
train travel is indicated when the number or proportion of satellites of comparatively low signal strength is comparatively high.
